(19) United States
(12) Patent Application Publication
(10) Pub. No.: US 2007/0233569 A1
(43) Pub. Date: Oct. 4, 2007

(54) WORLDWIDE WEB BASED DELIVERY OF SPORTS AND ACADEMIC DIGITAL CONTENT

(76) Inventors: Edward KELLEY, Ellicott City, MD (US); Carlos Escaffi, Finksburg, MD (US)

Correspondence Address: DUANE MORRIS, LLP;IP DEPARTMENT, 30 SOUTH 17TH STREET, PHILADELPHIA, PA, 19103-4196, US

(21) Appl. No.: 11/692,081

(22) Filed: Mar. 27, 2007

Related U.S. Application Data
(60) Provisional application No. 60/786,012, filed on Mar. 27, 2006.
(60) Provisional application No. 60/812,976, filed on Jun. 13, 2006.
(60) Provisional application No. 60/802,796, filed on May 24, 2006.
(60) Provisional application No. 60/813,334, filed on Jun. 14, 2006.

(51) Int. Cl. G06Q 30/00

(52) U.S. Cl. 705/14

(57) ABSTRACT

Process of generating a web-based high school sports, academic, extracurricular activity, youth/club level youth sports and adult sports league website portal includes obtaining at least one of academic, extracurricular activity, high school, youth level, club level, or adult league sports based content. The process further includes generating web pages for at least one of schools, teams, players, and students allowing users to view academic, extracurricular activity, high school, youth level, club level, or adult league sports based content of the at least one schools, teams, players, and students and directing advertising to the users through interaction with the web pages based on at least one the schools, teams, players, and students.

### CROSS-REFERENCE TO RELATED APPLICATIONS

This application claims priority under 35 U.S.C. §119(e) to provisional U.S. Patent Application No. 60/786,012, filed on Mar. 27, 2006; provisional U.S. Patent Application No. 60/812,976, filed on Jun. 13, 2006, provisional U.S. Patent Application No. 60/802,796 filed on May 24, 2006, provisional U.S. Patent Application No. 60/813,334 filed on Jun. 14, 2006, the disclosures of which are expressly incorporated by reference herein in their entirety.

### BACKGROUND OF THE INVENTION

1. Field of the Invention

The invention is directed to a web-based multi-media vertical portal (“vortal”) focused on sports in High Schools, Youth Sports/Club Sports and/or Adult League Sports. More particularly, the invention delivers digital content capable of engaging these key audiences:

Players & Their Families

Athletic Directors and Youth Sports Administrators

Coaches & Their Staff

Referees and Officials

Local Businesses and Organizations

The “Fan” (all visitors interested in these sports)

Moreover, the invention is directed to a method of providing a sports-based and/or academic-based network portal with a personal expression of a youth sports, club sports athlete and/or student, and in particular a profile of their athletic and/or academic capabilities.

The invention provides in-depth information, training, education, entertainment and facilitates interaction; while, at the same time, providing management tools and resources, as well as funding resources, to High School, Youth Sports/Club Sports and Adult League Sports Organizations. Moreover, the invention increases interest in the sports and players, while providing a revenue source through electronic Commerce (eCommerce) and targeted advertising, subscription services and like.

2. Related Art

Many sports based websites that have some form of digital content are not directed towards High school, Youth/Club Level and/or Adult League sports. These websites at best merely provide limited newspaper type information.

Additionally, previous approaches to creating social networks via the World Wide Web have not been directed to youth sports, club sports or student academics. These approaches did not include any ability to display beneficial information for the athlete and/or student and advertising could not be directed to an athlete, student, fan or the like.

Accordingly, there is a need for a web-based multi-media source of High School, Youth/Club Level and/or Adult League sports digital information content that provides a rich source of digital content for every aspect of these levels of sports and that benefits the community.

### SUMMARY OF THE INVENTION

The invention meets the foregoing needs and allows a user to obtain digital content on High School, Youth/Club Level and/or Adult League sports that increases the interest in the sport, provides a rich source of multi-media digital information that benefits the community and includes other advantages apparent from the discussion herein.

Additionally, the invention is directed to a High School, Youth/Club and/or Adult League Sports Portal, a Vertical Portal or “Vortal,” that is a web-based system that may be a single point of access to sports related information collected and provided from local communities. The Vortal may include User Registration and Authentication; Personalized Content; Directory Based Formation Structure (Player, High School, Youth Sports, Adult Leagues); Community “Building Tools;” Player (Athletes) Social Network; Subject Specific Searches; Feedback Channels; and Educational Resources.

Moreover, the invention is directed to a social networking system that is sports and/or student-activity specific. Accordingly, the invention may encompass content based on kids playing sports from their first sports experiences through high school sports. These sports include high school sports, youth sports, club sports, and/or other sports organizations whose participants may include ages six through high school age athletes.

Users of the system may be provided with various web-based tools to generate and create their personal expression. These tools may include various different functions including an athlete profile, activities profile and/or academic profile. Each of these tools may be described as a Digital athlete/Activities/Academic Profile or iDAP. The iDAP is a multi task tool that may allow young students and/or student athletes to present their academic, athletic and other accomplishments via a fun, creative and dynamic tool that may allow for multi media presentations.

The iDAP tool may allow photographs, music, videos, statistical information, academic recommendations, awards, and/or other distinctive records of young athletes and/or students. The iDAP also provides the students and/or student athletes with organizational and personal management tools. These may include online interactive two-way calendar systems that synchronize with parents' schedules. Moreover, these schedules may also synchronize with other young students and student athletes living in the same home. Synchronization of the schedules allows parents and/or students to better deal with the often chaotic lifestyle that plagues the young students in school activities as well as student athletic activities in his or her family. The iDAP also may serve as a one-stop entertainment source. The iDAP may have other features integrated such as a sports and activity specific information source such as RSS (really simple syndication).

The iDAP may allow for the display of personalized music and portal interface, photographs and videos of the student athlete's sports life, access and links to other athletes iDAPs, and the student athletes' teams and activities websites. Moreover, the iDAP may provide a link to other high school and youth sports websites.

The users of the iDAP may be able to communicate by using the website provided text messaging, email and/or instant messaging functions. In addition, the iDAP may provide powerful search capabilities to allow the student and/or student athlete find other students and student athletes by using different filters such as competition level, school, common interests, activities, sports, and the like. The iDAP may be accessible by college recruiters and admission officers seeking student athletes and/or well-rounded students engaged in extracurricular activities.

According to one aspect of the invention, a process of generating a web-based high school sports, academic, extracurricular activity, youth/club level youth sports and adult sports league website portal that includes the steps of obtaining at least one of academic, extracurricular activity, high school, youth level, club level, and adult league sports based content, generating web pages for at least one of schools, teams, players, and students allowing users to view at least one of the academic, extracurricular activity, high school, youth level, club level, and adult league sports based content of at least one of the schools, teams, players, and students, and directing advertising to the users through interaction with the web pages based on at least one the schools, teams, players, and students.

The step of directing advertising may include directing advertising limited to at least one gender, age, locality, specific school, town, city, region, and sport. The step of directing advertising further may include generating revenue from the advertising that is shared with at least one the schools, teams, and community. The at least one of the academic, extracurricular activity, high school, youth level, club level, and adult league sports based content may include at least one of game schedules & results, game headlines, detailed athlete, team, school, conference statistics, news articles, photo galleries, video content, system generated sports statistics, league standings, league leaders, conference schedules, players, articles, leagues, win-loss records schedules, playoffs, games, highlights, bloopers, and internet radio information. The step of generating may include statistical and video information of at least one of the schools, teams, players, and students. The step of generating may include the step of allowing sports recruiters from colleges and universities to view the statistical and video information of at least one of the schools, teams, players, and students. The step of generating web pages for at least one of schools, teams, players, and students may include allowing at least one of players and students to personalize the academic, extracurricular activity, high school, youth level, club level, and adult league sports based content. The portal may form a single point of access for a community. The step of generating web pages for at least one of schools, teams, players, and students may take place locally in the community.

According to another aspect of the invention, a machine-readable medium including instructions, which, when executed by a general-purpose processor cause the processor to generate a web-based high school sports, academic, extracurricular activity, youth/club level youth sports and adult sports league website portal, the instructions include instructions for obtaining at least one of academic, extracurricular activity, high school, youth level, club level, and adult league sports based content, instructions for generating web pages for at least one of schools, teams, players, and students allowing users to view at least one of the academic, extracurricular activity, high school, youth level, club level, and adult league sports based content of at least one of the schools, teams, players, and students, and instructions for directing advertising to the users through interaction with the web pages based on at least one the schools, teams, players, and students.

The instructions for directing advertising may include directing advertising limited to at least one gender, age, locality, specific school, town, city, region, and sport. The instructions for directing advertising further may include generating revenue from advertising that is shared with at least one the schools, teams, and community. The at least one of the academic, extracurricular activity, high school, youth level, club level, and adult league sports based content may include at least one of game schedules & results, game headlines, detailed athlete, team, school, conference statistics, news articles, photo galleries, video content, system generated sports statistics, league standings, league leaders, conference schedules, players, articles, leagues, win-loss records schedules, playoffs, games, highlights, bloopers, and internet radio information. The machine-readable medium including instructions may further include instructions for generating statistical and video information of at least one of the schools, teams, players, and students. The machine-readable medium including instructions may include instructions for allowing sports recruiters from colleges and universities to view the statistical and video information of at least one of the schools, teams, players, and students. The instructions for generating web pages for at least one of schools, teams, players, and students may include allowing at least one of players and students to personalize the academic, extracurricular activity, high school, youth level, club level, and adult league sports based content. The portal may form a single point of access for a community. The instructions for generating web pages for at least one of schools, teams, players, and students may take place locally in the community.

According to another aspect of the invention, a process of generating a web-based high school sports, academic, extracurricular activity, youth/club level youth sports and adult sports league website portal includes the steps of receiving at least one of academic, extracurricular activity, high school, youth level, club level, and adult league sports based content from users, generating web pages for at least one of schools, teams, players, and students allowing users to view at least one of the academic, extracurricular activity, high school, youth level, club level, and adult league sports based content of at least one of the schools, teams, players, and students, and directing advertising to the users through interaction with the web pages based on at least one the schools, teams, players, and students, wherein at least one of the academic, extracurricular activity, high school, youth level, club level, and adult league sports based content includes at least one of game schedules & results, game headlines, detailed athlete, team, school, conference statistics, news articles, photo galleries, video content, system generated sports statistics, league standings, league leaders, conference schedules, players, articles, leagues, win-loss records schedules, playoffs, games, highlights, bloopers, and internet radio information.

The step of directing advertising may include directing advertising limited to at least one gender, age, locality, specific school, town, city, region, and sport. The step of directing advertising further may include generating revenue from the advertising that is shared with at least one the schools, teams, and community. The process of generating may include a step of generating statistical and video information of at least one of the schools, teams, players, and students. The process of generating according may include a step of allowing sports recruiters from colleges and universities to view the statistical and video information of at least one of the schools, teams, players, and students.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention, are incorporated in and constitute a part of this specification, illustrate embodiments of the invention and together with the detailed description serve to explain the principles of the invention. No attempt is made to show structural details of the invention in more detail than may be necessary for a fundamental understanding of the invention and the various ways in which it may be practiced. In the drawings:

FIG. 1 shows a breakdown of the various components of the invention;

FIG. 2 shows some of the various web pages constructed according to the principles of the invention; and

FIG. 3 shows an exemplary process of operating a web page according to the principles of the invention.

### DETAILED DESCRIPTION OF THE INVENTION

The embodiments of the invention and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the invention. The examples used herein are intended merely to facilitate an understanding of ways in which the invention may be practiced and to further enable those of skill in the art to practice the embodiments of the invention. Accordingly, the examples and embodiments herein should not be construed as limiting the scope of the invention, which is defined solely by the appended claims and applicable law. Moreover, it is noted that like reference numerals represent similar parts throughout the several views of the drawings.

The invention is directed to a web based system providing a single point of access for each community to local high school activities and youth and/or club sports organizations. More specifically, the invention provides a web access to resources and tools for athletic directors, administrators, teachers, clubs, coaches, students, players, and parents. Accordingly, as described in greater detail below, each of these individuals may use these web accessed resources and tools at a single point for each community for interaction therewith. Moreover the invention is directed to a web based sports and activity social networking program that may be linked to teams and schools. This social networking program provides various communication systems as described in detail below. Moreover this network may be community based and allow for an advertising or marketing reach to consumers by businesses that is laser focused on that particular community of interest. Additionally, the web based system of the invention includes numerous control measures to prevent and control inappropriate content. Finally the content of the web based system of the invention is user generated and highly customizable as set forth in greater detail below.

In other words, the web based system according to the invention is a purpose driven web based sports and academic community for all. The web based system of the invention allows for a local entrepreneur presence and format that builds a sense of community for all. Moreover the web based system according to the invention allows for a community for all activities, not just sports. In this regard, every type of academic or sports related activity can form a part of the community of the web based invention. This very same community provides for targeted advertising systems for local and regional businesses as noted in greater detail below. This same community also offers protected systems managed by schools, organizations, and parents to ensure that the contents is regulated accordingly. Finally, in order to keep the content fresh in the web based system according to the invention, a content “freshness” system is in place to ensure that local partners, motivated providers, and corporate enforcement ensure that the content on the web based system of invention remains fresh and continues to allow the community to grow.

The invention is directed to providing benefits to the local community by creating a rich, sports-related content website, in order to draw significant Website viewership. The viewership may then produce revenue from Internet advertising and web-based product sales. The revenue then may be shared with High Schools and Youth/Club Level Sports Organizations, as well as Adult League Organizations, who collectively represent a local community of participants and viewers.

More particularly, the invention is directed to providing Players and their Families; Coaches and Administrators of Sports Programs; Referees and Officials; Community Members (Businesses, Civic Groups, Neighborhoods, Schools, Local Government and Support Services), Businesses and Organizations; and the Sports Fan, with access to beneficial programs, funding, information, and entertainment—all revolving around local, regional and national High School and Youth Sports. All of these local communities, as well as the social network of players, may be connected together for communications and social networking within the sports related field.

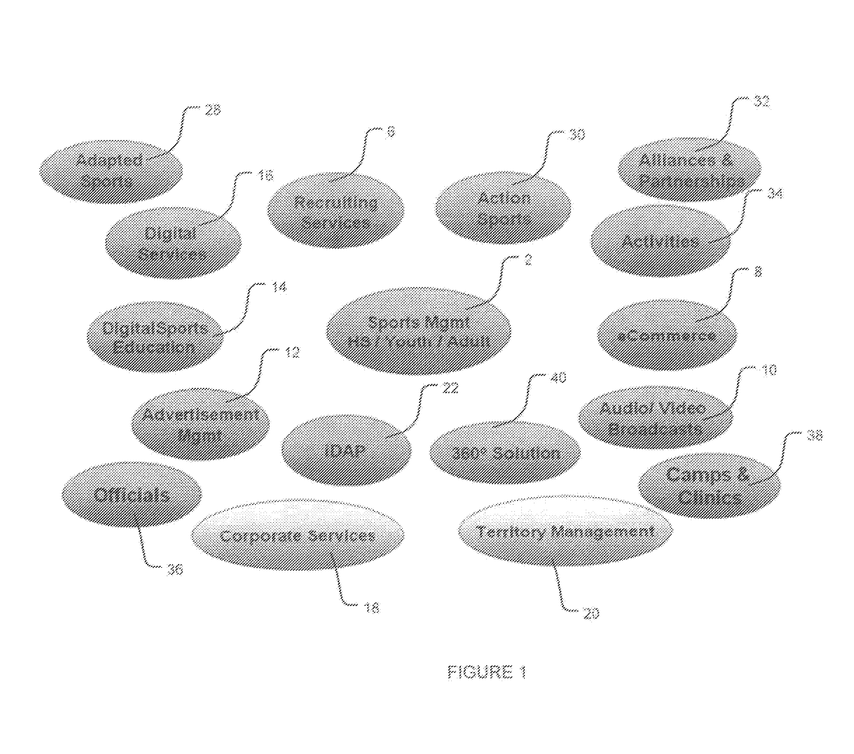

In order to achieve this, the invention may include various portions that generate or support the website having a web-based multi-media source of High School, Youth/Club-Level and/or Adult League sports digital information. In particular, as shown in FIG. 1, the first portion of the invention is directed to sports management 2. The sports management portion 2 is for interaction of high school, youth/club level and adult sports league administrators, coaches, managers, and staff coordinators of various sports.

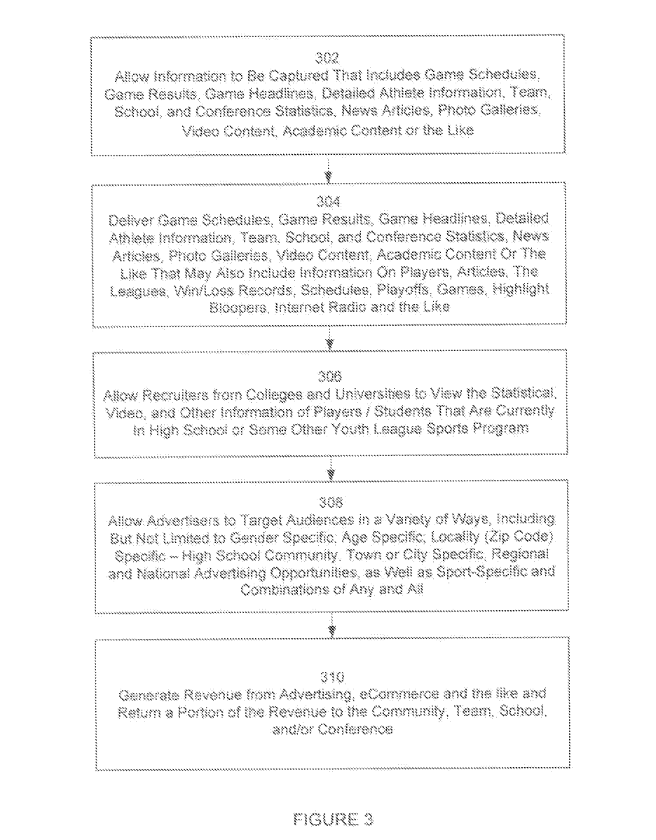

The management portion 2 of the invention may be designed to have a certain level user security to control the content thereof. Accordingly it may be password protected or the like. Moreover, the sports management portion 2 of the website allows for information to be captured that includes game schedules, game results, game headlines, detailed athlete information, team, school, and conference statistics, news articles, photo galleries, video content or the like (see 302 of FIG. 3). Moreover, the sports management portion 2 may also include different other sport's statistics. In particular, the statistics may include league standings, league leaders (team and player), conference schedules and the like. Much of this information may be contributed by the community.

Accordingly this portion may include any one or more of the following features:

Secure & Managed Community Contributed Content

Simplicity/User Friendliness/Access Levels

Technology Availability to Users

Empower all users to enter content

Online Tutorials

Sports Information

Game Schedules & Results

Game Headlines

Detailed Athlete, Team, School, Conference Statistics

News Articles

Photo Galleries

Audio & Video Content

Searchable Archives

System Generated Sports Statistics

League Standings

League Leaders (Team & Player)

Conference Schedules

Online Editing & “One-Step” Approach

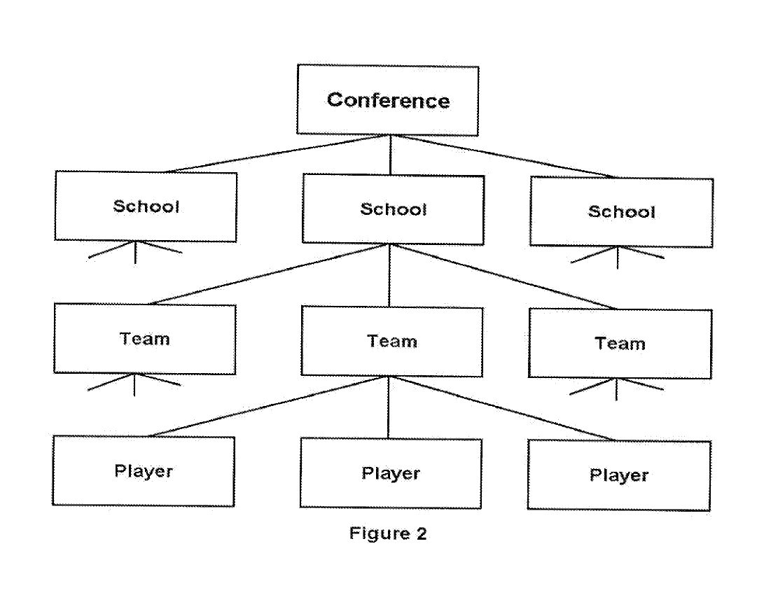

All this information may be uploaded or generated through the sports management portion 2 of the vortal and may then be viewed as shown in FIG. 2. In particular, the content may be viewed via web connected computer, PDA or any other type of commercial electronic device having web access. The content may include information on players, articles, the leagues, win/loss records, schedules, playoffs, games, highlight bloopers, internet radio and the like (see 304 of FIG. 3). The content may be template based, may have a particular work flow management, may further include some form of security management, may have a SMS gateway and may include search capabilities. In particular, the search capabilities may allow a user through the use of a search engine to search the content of the digital media sports website. Search capabilities may include a directory based structure focused on High Schools, Youth/Club Sport and/or Adult League Sports Organizations, Players and local businesses. The search may include SQL technology or the like.

The information that is provided to the sports management portion 2 may be gathered by various interns and other people who are willing to accumulate the information (i.e., statistics, video, digital pictures, etc.) and upload it to the portion 2 of the website. Accordingly, it may be beneficial to recruit interns to gather, assemble, and upload data. Recruiting may be achieved by any known approach.

The invention may include the ability for sports recruiters from Colleges and Universities view the statistical, video, and other information of players that are currently in high school or some other youth league sports program (see 306 of FIG. 3). In particular, the recruiting services portion 6, shown in FIG. 1 may allow for a recruiting service that may be a subscription-based service. This is ideal for Colleges and Universities on a budget and allows a recruiter to have access to iDAPs (Digital Athlete Profile—A personalized player web site that provides meaningful and rich content regarding a players: physical attributes; sport specific skills; individual and team achievements; academic resume; extracurricular and community based biography; game films and highlights). The iDAP may also serve as a sports specific social networking and communications directory that may allow young athletes to share common interests in regard to their individual and team accomplishments; and, may allow for interaction between these players in their ongoing efforts to better understand current and future sports opportunities (such as Travel and Elite Club Level programs; college scholarships, etc.). The iDAPs also may allow the typical recruiter to make a judgment on whether or not to recruit a particular player based on a broader review of the player's accomplishments, as opposed to relying on a player's single game film. The access to the iDAP network provides the Colleges, Universities and Junior Colleges or Community Colleges with limited budgets with economically favorable access to valuable information typically needed to determine the appropriateness of offering academic or athletic scholarships. Additionally, in this recruiting services portion 6 there may also be discussion forums and “Where are they now?” type of alumni services and digital content.

Accordingly this portion may include one or more of the following features:

Subscription Services for Colleges & Universities

Access to iDAPs

Access to Game Film

Searchable & Sortable Databases

“College Billboard” Information

College Awareness

Discussion Forums

Local Recruiting News

Links to Other Recruiting Resources

Another aspect of the invention is the eCommerce (electronic Commerce) portion 8 shown in FIG. 1. The eCommerce portion 8 of the invention may include the ability for a player, parent and other interested parties to buy merchandise through the eCommerce portion 8 of the website. In particular, the eCommerce portion 8 may include the ability to purchase posters and memorabilia of the various teams, schools and conferences that are hosted by the website. Moreover, the eCommerce portion 8 may also include team sales that may include equipment, uniforms and the like. Finally, another area of the eCommerce portion 8 may be the direct consumer sales of different merchandise. In particular, the direct consumer sales portion may include digital photography (vast inventory of sports related (on or off the field) photos provided by local communities of players, parents, fans, coaches and administrators), digital video highlights (created from a web embedded tool that allows teams to create season highlight films of all players throughout the season, that may be shared and sold at season ending banquets, digital scrapbooks (created from a user friendly editing tool embedded in the web site that provides parents and relatives the ability to create a virtual scrapbook of photos, film, articles and other media content that spans a player's sports career from its earliest entry into little league to the final days of high school (and college) sports activities—which in turn may offer powerful memorabilia keepsakes for the player, parent or relatives, and iDAP “premium” (as previously described). Other eCommerce opportunities may exist by generating buying power throughout the collective group of High Schools, Youth/Club Level Sports and/or Adult league Sports organizations. Accordingly, the eCommerce section 8 provides a source of revenue from the sales of the various merchandise as described.

Accordingly this portion may include:

Posters & Memorabilia

Team Sales

Trophies and Awards

Digital Photograph Shots

Digital High Lights™

Scrapbooks

Affiliate Programs

Team Web Site—Offline CD

Bundle Products

Another aspect of the invention is directed to a portion for streaming video 10. In particular, FIG. 1 shows the streaming video portion 10 that may be available on the website as a digital media. In particular, the streaming video portion 10 includes various streaming video contents that may be seen from the website vortal. The video may include current and archived season and playoff games that may be presented free of charge to increase interest. Moreover, the streaming video may include highlights, bloopers, amazing moments, and archived games. As a source of revenue, video ads may be inserted at any portion of this type of video content. Moreover, the ability to search video via indexing through a player/team and organization specific directory is contemplated for use in the invention as part of the streaming video portion 10 shown in FIG. 1.

Accordingly this portion may include:

In-Season & Post-Season Games

Highlights

Bloopers

“Amazing” Moments & Finishes

Digital Classics: Archived Games

Video Ad Insertions

Search Video Indexing

Cable T.V. Channel

Internet Radio

Another important aspect of the invention is the advertisement (ad) management portion 12 shown in FIG. 1. One of the sources of revenue for the invention may be through advertising and the ad management portion 12 shown in FIG. 1 may be the single point for advertising management. In particular, advertising placement may be in the form of buttons, banners, rectangles, or towers throughout the website. It is contemplated that the ad management portion 12 may generate and place rich media and various video ad placements throughout the website. Additionally, it is contemplated that the advertisement management portion 12 may also include an advertisement library, campaign management, email management, agency solutions, customized affiliate programs, and reporting analytics to ensure that advertising is proper, properly targeted, and efficiently and quickly implemented. Furthermore, the vortal offers advertising products to potential advertisers, which provide targeted audiences and targeted reaches in a variety of ways, including but not limited to gender specific; age specific; locality (zip code) specific—high school community, town or city specific, regional and national advertising opportunities, as well as sport-specific and combinations of any and all (See 308 of FIG. 3).

Accordingly this portion may include:

Cutting Edge Advertising Tools & Products

Rich Media & Video Ad Placements

Advertisement Library

Campaign Management

Agency Solutions

Customized Affiliate Programs

Reporting Analytics

Industry Standards

Search Engine Optimization—Local, Regional & National

Free Local Classifieds

Free Coupons

The revenue then may be shared with High Schools and Youth/Club Level Sports Organizations, as well as Adult League Organizations, who collectively represent a local community of participants and viewers (See 310 of FIG. 3).

Another part of the invention is the education portion 14. Often youth athletes and their parents do not have a single good source of youth sports education. The education portion 14 provides a library of different sports information. In particular, the sports education portion 14 may include sports focused communities. For example, the football community may have various information related to football or the football player. Similar communities may also exist for other sports. Moreover, the education portion 14 may include discussion forms, web casts, training video, online resources and seminars, athletic training education, field/umpire schooling, coaching clinics, links to academic resources, training and fitness programs, and “heroes” which may include motivational interviews with sports personalities and inspirational stories. In particular, the education portion 14 can provide a rich source of information for the athlete or the athlete's parent for example only.

Accordingly this portion may include:

Sports Focused Online Communities

Discussion Forums

Training Videos

On-line Resources & Seminars

Athletic Training Education

Field/Umpire Schooling

Coaching Clinics

Academic Resources

Training & Fitness Programs

Links to Resources

FAQ

Online Chat

Knowledge Base Content—User Generated Content

A further aspect of the invention is directed to digital services as shown by the digital services portion 16. The digital services portion 16 provides various different digital services to the user of the website. In particular, there may be sports alerts which may alert a user of the website to different changes in schedules, in practices, in team registration, camps, clinics, subscription services, fund raising, tickets for kids and the like. Digital services may be a portion on the website itself or may be an email, text based type of delivery or the like. By accessing these services through the website/vortal, a user can create a variety of groups (teams, coaches, families, schools, etc.) that may be then communicated to through electronic text messaging and/or voice and email messages that are instantly transmitted to all members of each group.

Accordingly this portion may include:

Sports Alerts

Camps/Clinics/Team Registration

Subscription Services

Video

Recruiting Services

News Letter

Content Delivery

A further portion may be directed to a Playbook (not shown) site that provides those responsible for administering or coaching their sport/team or organization with useful tools and resources that may reduce time or difficulties involved with the tasks associated with their responsibilities; or, may provide tools or resources that increase the availability of funds necessary to run their teams or organizations; including High School Booster or Spirit organizations.

Accordingly this portion may include:

High School AD Resources & Tools

Youth League Administrator Resources & Tools

Coaching Tools

Booster Club Tools

Umpire/Referee/Officials

Revenue Management Applications

Ticket/Card Transactions

Knowledge Base Applications—Best Practices (User Contribution) AD Communication Community

Athletic Trainers

Yet another portion may be directed to an Alumni Services section (not shown) that may provide systems for Alumni Communications; Alumni Networking; Scholarship Programs; Foundation Programs; Mentor Programs; Fundraising programs; “Where Are They Now” searches; Archived Films; and Featured Speakers.

Accordingly this portion may include:

Alumni Communications

Alumni Social Networking

Search Directory

aDAP (Alumni iDAP)

Scholarship Programs

Foundation Programs

Mentor-Intern-Career

“Where Are They Now”

Archived Film

Featured Speakers

Student Athlete Advancements to College

Another portion may be directed to the Digital Athlete Profile Services 22 (iDAP) as previously described. This portion may include:

Social Networking capabilities

Online Resume Display information

Academic & Extracurricular information

Letters of Recommendation

Awards & Achievements

Coach, School & Club Sport Contact Information

Vital Statistics/Athletic information

Community Service information

Personal Highlight Videos

Personalized Photo Gallery

Team Game Films

Links to School and Club Sites

Peer Communication Systems

Portion 18 is directed to various corporate services that may be provided to the franchiser of the invention. Accordingly this portion may include:

Marketing & Sales Management

Accounting Management (Billing, Accounts Receivable, General Ledger, and Reporting, Account, etc.)

Audit & Operations

Additionally, as shown in portion 20, the territory management is another portion of the invention that may allow this type of internet based service to be operated by various other individuals. Again, the details of this portion are not germane to the invention. Corporate Services Provided To Partners

Training

Operations

Marketing

Sales

Accounting

Technical Support

Partner Management Tools

Web Audit (Scouting Report)

Playbook

Prospective Advertiser Presentation (Collateral Library)

High School and Youth/Club Sports Presentation

Another aspect of the invention may include the ability to search or review the information that is listed on the website via conference, school, team or player.

The ability to advertise specifically to a conference, to a school, to a team, to a player, including a particular age group or a particular gender, is very easily accomplished with the web page breakdown described below. In particular, it is possible to target advertising that is set forth in the advertisement management portion 12 to a specific area such as:

Gender

Age Group

Team

Sport Specific

School Specific

Town/Community Specific

Market (City/ADI)

Multiple Reaches (combos)

In addition to the specific target internet type advertising, the invention further includes revenue opportunities including services, sale of digital content product sales as noted above, subscriptions, including subscriptions to the website itself, website partnering, or the like.

In addition to the advertising described above, local “Classified” directories may be provided, allowing local viewers to sell or buy items commonly associated with Local Classifieds, including “Items for Sale;” Autos for Sale; local job opportunities; etc.

The invention may also include an adapted sports portion 28 which may be directed to serving the athletic needs of children with disabilities. More specifically, the adapted sports portion 28 may address the various sporting, education, and community needs for over 1.5 million children with disabilities. Thus, the adapted sports portion 28 generates an increasing community amongst all individuals in the community.

The invention may further include an action sports portion 30. The action sports portion 30 may be directed to such extreme or action sports including, but not limited to, skating, snow, water, and extreme “action” sports. Such action sports have grown dramatically in the past decade. The action sports portion 30 increases the education and builds the relationships in the community in the action sports area.

The invention may further include an alliances and partnerships portion 32. The alliances and partnerships portion 32 may include various programs that are complimentary to the invention. More specifically, the alliances and partnerships portion 32 may be any one or more of a national, regional, and local level including various programs. These programs being synergistic and complimentary to the web based system according to the invention.

Another portion of the invention is the activities portion 34, in this regard the activities portion 34 allows various organizations within high schools and youth clubs to share various resources and revenue sharing opportunities. Most high schools and youth clubs can benefit from utilizing the same systems, tools, resources and revenue sharing opportunities offered to teams and organizations nationwide. There may be 100 or more activity programs in any given high school. These activities may include photography, media, music, band, drill team, drama, debate and many others. Accordingly the activities portion 34 provides the same systems, tools and resources to share in such opportunities for such activities.

The camps and clinics portion 38 is another optional portion in the invention. The camps and clinics portion 38 provides an effective way to advertise programs and manage the registration process for camps and clinics. Accordingly the camps and clinics portion 38 may provide a link to the website through the invention thus increasing opportunities for users of the invention to experience the benefits of camps and clinics while building a sense of community through the use of such camps and clinics for the users and users' children.

A 360 degree (360°) solution portion 40 is another portion that may be integrated into the invention. The 360° solution portion 40 allows athletic directors, coaches and league administrators to manage their programs from A to Z. Accordingly the 360° solution thus gives these athletic directors, coaches, and league administrators a complete all around view of their various responsibilities and allows them to manage these responsibilities through the community that is constructed according to the invention.

The officials portion 36 is another portion that may be implemented in the web site constructed according to the principles of the invention. The officials portion 36 may provide links and programs for locating, scheduling, evaluating, and paying game officials. Thus, the officials portion 36 integrates every single level of management, including the officials, at a single point of access by the community.

FIG. 2 shows some of the various web pages constructed according to the principles of the invention. In particular, the invention may have a web page for every player, for every team, for every organization and for every age group. The web hierarchy may take any form, but it is contemplated that the hierarchy may include National, State, Conference or Organization, School or Sport, Team, and Player.

FIG. 2 shows an exemplary layout of a conference, with multiple schools, teams and players. Note only a portion of the schools, teams, and players are shown. Further as shown in FIG. 2, every school, conference, team and player may be provided with a web page with links connecting each. The web page for every player may be the player's iDAP as described below.

As an overview, the iDAP is a personalized website provided to every athlete or student participating in sports and activities. The features of the iDAP may include personalized content, resume for display of academic, athletic, and extracurricular activity achievement, photographs and videos.

The system supporting the iDAP constructed according to the invention protects children from outside intruders and monitors for inappropriate display of contents. Moreover the iDAP allows coaches, administrators and parents to have the final say on participation levels.

In particular, the iDAP may include four different major areas. These areas may include facilitating interaction, entertainment, information and education, and community networking. In particular, the area of facilitating interaction may include a calendar, blogs, SMS messaging and communication, common interests group and networking, and broadcast and cable channels. More specifically, the calendar may include various calendar features for the student or student athlete. The calendar may be able to accept various dates for sports and/or academic-related activities whether entered by the student and/or student athlete, the parents, coaches and/or teachers.

The calendar feature may more specifically support the ability to make various events or calendar inserts public and private. In this regard, an individual may designate who can see the calendar events and this may allow for increased privacy. Moreover, the calendar feature allows for the insertion of group events. In particular, a team coach may designate a team and then when inserting a particular calendar event may insert it for the entire team at one time. Such integration allows for the entire team to be integrated with a single action and moreover allows for the integration of a school calendar therewith. This allows teachers and/or coaches to receive and send various alerts and messaging based on various calendar events. Moreover, the calendar provides for reminders for the various upcoming activities through the iDAP interface and/or any other form of communication associated therewith. Additionally, the calendar may include various filtering capabilities. This may allow the iDAP user to filter various calendar events by sports, practice, school events, personal and the like. Altogether, the calendaring capability may allow for the integration with various teams, parents, siblings and other network partners. Moreover, the calendar feature may provide a two-way communication link and may include advising features with the students, parents, and/or coaches and teachers.

The iDAP may further include online journal (blog) capabilities. Members will be able to share their personal journal with other members. Moreover, the facilitate interaction section may include SMS-type messaging and communication through the use of instant messaging and/or other known forms of chat or electronic communication.

The blog feature of the iDAP may, more specifically, provide for archive support. In particular, the blog feature may have the capability to archive information over time and store the same. Moreover, the blog feature may also provide commenting support. In this regard, the blog may allow for other iDAP users to provide comments and notes to the active blog. Finally, the blog may also provide deletion support in order to delete subject matter that is no longer desired to be part of the blog.

Additionally, the iDAP may allow for the generation or creation of common interest groups and networking. In particular, a student and/or student athlete may be able to create or join a common interest group and network with the various individuals that are part of or that join this group. Finally, the facilitate interaction portion may allow for broadcast or cable channel information to be sent to various iDAPs and/or received by various iDAPs. Videos may be streamed through the infrastructure that could be seen by all iDAP members.

The iDAP may further include the ability to provide entertainment. In particular, the iDAP may include the ability to generate multimedia presentations. The multimedia presentations may include photographs, music and/or videos. The photographs, music and the videos may be of the student and/or student athlete or may include some of the various school functions or sports functions related therewith.

Moreover, the student or student athlete may be able to customize their particular iDAP portal with a particular interface or look. This can include background colors, music, wallpaper and the like. Moreover, the ability to customize the user interface gives the user the freedom to choose different user interface skins for the iDAP. Moreover, the iDAP tools may allow the user to position the iDAP contents wherever they desire and change the contents as they desire.

The messaging capability provides an iDAP user the ability to send various SMS messages and the like to other users in their network of iDAPs. Moreover, the SMS messaging allows for iDAP users to send invites to other iDAP users electronically.

The multimedia portion of the iDAP provides for the display and upload of various photographs and videos. In particular, the multimedia portion of the iDAP provides a capability to upload and display a photo gallery with album-type support. Similarly, the multimedia portion of the iDAP provides a video gallery capability allowing videos to be uploaded and displayed again with album-type support. Additionally, the multimedia portion of the iDAP allows for control of comments with respect to the various photographic images and/or videos. Users of the iDAP may allow for various images and videos to be rated with respect to how well they like or dislike the various photographs and/or images. Finally, the multimedia portion of the iDAP may allow for images and/or videos to be imported from the main portal into the personal iDAP of the student or student athlete.

Another feature of the iDAP is to inform and educate the users. In particular, the iDAP may allow for the collection, upload and display of sports news, sports statistics, various sports articles and other educational-type features for display on the iDAP. Moreover, the iDAP may allow for RSS-type information subscriptions for displaying various RSS-type media content. The RSS information subscription information may allow users to subscribe to content both internal to the iDAP system and also external to the iDAP such as news websites and the like.

Moreover, the iDAP may allow for personalized or related links to be added to the iDAP that are directed to a particular area of interest of the user. Moreover, the iDAP is contemplated to include an HTML wysiwyg-type editor (wysiwyg—what you see is what you get). In particular, the HTML editor may allow an iDAP user to design and generate a web page using straightforward-type editing actions.

The iDAP may also include various other types of sources of information including FAQs (frequently asked questions), a knowledge base, and announcements section. Accordingly, the iDAP user may create, add or access each of these type contents to enhance enjoyment of their personal iDAP or other iDAPs. The iDAP FAQs and knowledge base may provide a central area where athletes may view answers to questions or the knowledge base for a particular sports and/or academic-related subject. Additionally, it may provide the ability for a posting to the knowledge base. Moreover, the iDAP may allow online resumes, alumni services, and recruiting tools.

The online resume of the iDAP may allow for athletes to maintain their resume for college and the like. The resume may be based on multiple resume templates that may be available through the iDAP system. Moreover, the alumni services may allow alumni to maintain their iDAP and coordinate their activities through the system. The alumni service may include various online directory services.

The iDAP also may provide college recruiters with various recruiting tools. In particular, a recruiting tools section may provide recruiters with tools to search and choose for the right candidate. In particular, a recruiter may able to search using various search criteria based on statistics, academic information, geographic considerations, and the like.

The iDAP may further include generic search capabilities. In particular, a search may be allowed from a public website as well as from the iDAP portal. The search within the iDAP may allow for filters and/or categories to enhance the search. Moreover, the iDAP system may allow for the support of keyword searches.

The iDAP system may allow networking capabilities with other athletes and/or students' iDAP. In this regard, users may be able to view other iDAPs within their network or their friends in one single place. Moreover, users may be able to communicate via alerts and SMS-type messages within their network.

An additional feature that may be used with the iDAP is the control and monitoring feature. In particular, the iDAPs may include personal password assignments and the content may be protected with these passwords. In this regard, a user may be able to limit access and control of their iDAP based on the personal password. Moreover, the iDAP system may allow for a peer reporting system. In this regard, if a user or peer of the iDAP system sees any improper subject matter, they may be able to report this to a system administrator, coach, and/or teacher for control and/or removal thereof. Additionally, coaches, sports administrators and others may have access to all of the iDAPs with a special password in order to control and monitor content thereof. Finally, parents may be able to control content through special parental control features to ensure that the students or student athletes have a limited and controlled content as directed by their parents.

The iDAP may also allow for other entertaining-type network capabilities including favorite iDAP pages and/or most visited-type features. Accordingly, the iDAP system may allow for voting on what is the favorite iDAP or may allow for a counting capability to count the number of web page hits to determine the most visited iDAP.

For a firmware and/or software implementation, the methodologies may be implemented with modules (e.g., procedures, functions, and so on) that perform the functions described herein. Any machine readable medium tangibly embodying instructions may be used in implementing the methodologies described herein. Memory may be implemented within the processor or external to the processor. As used herein the term “memory” refers to any type of long term, short term, volatile, nonvolatile, or other memory and is not to be limited to any particular type of memory or number of memories, or type of media upon which memory is stored.

While the invention has been described in terms of exemplary embodiments, those skilled in the art will recognize that the invention can be practiced with modifications in the spirit and scope of the appended claims. These examples given above are merely illustrative and are not meant to be an exhaustive list of all possible designs, embodiments, applications or modifications of the invention.

What is claimed:

1. A process of generating a web-based high school sports, academic, extracurricular activity, youth/club level youth sports and adult sports league website portal comprising the steps of:
obtaining at least one of academic, extracurricular activity, high school, youth level, club level, and adult league sports based content;
generating web pages for at least one of schools, teams, players, and students allowing users to view at least one of the academic, extracurricular activity, high school, youth level, club level, and adult league sports based content of at least one of the schools, teams, players, and students; and
directing advertising to the users through interaction with the web pages based on at least one the schools, teams, players, and students.

2. The process of generating according to claim 1 wherein the step of directing advertising comprises directing advertising limited to at least one gender, age, locality, specific school, town, city, region, and sport.

3. The process of generating according to claim 1 wherein the step of directing advertising further comprises generating revenue from the advertising that is shared with at least one the schools, teams, and community.

4. The process of generating according to claim 1 wherein at least one of the academic, extracurricular activity, high school, youth level, club level, and adult league sports based content comprises at least one of game schedules & results, game headlines, detailed athlete, team, school, conference statistics, news articles, photo galleries, video content, system generated sports statistics, league standings, league leaders, conference schedules, players, articles, leagues, win-loss records schedules, playoffs, games, highlights, bloopers, and internet radio information.

5. The process of generating according to claim 1 further comprising the step of generating statistical and video information of at least one of the schools, teams, players, and students.

6. The process of generating according to claim 1 further comprising the step of allowing sports recruiters from colleges and universities to view the statistical and video information of at least one of the schools, teams, players, and students.

7. The process of generating according to claim 1 wherein said step of generating web pages for at least one of schools, teams, players, and students comprises allowing at least one of players and students to personalize the academic, extracurricular activity, high school, youth level, club level, and adult league sports based content.

8. The process of generating according to claim 1 wherein the portal forms a single point of access for a community.

9. The process of generating according to claim 1 wherein said step of generating web pages for at least one of schools, teams, players, and students takes place locally in the community.

10. A machine-readable medium comprising instructions, which, when executed by a general-purpose processor cause the processor to generate a web-based high school sports, academic, extracurricular activity, youth/club level youth sports and adult sports league website portal, the instructions comprising:
instructions for obtaining at least one of academic, extracurricular activity, high school, youth level, club level, and adult league sports based content;
instructions for generating web pages for at least one of schools, teams, players, and students allowing users to view at least one of the academic, extracurricular activity, high school, youth level, club level, and adult league sports based content of at least one of the schools, teams, players, and students; and
instructions for directing advertising to the users through interaction with the web pages based on at least one the schools, teams, players, and students.

11. The machine-readable medium comprising instructions according to claim 10 wherein the instructions for directing advertising comprises directing advertising limited to at least one gender, age, locality, specific school, town, city, region, and sport.

12. The machine-readable medium comprising instructions according to claim 10 wherein the instructions for directing advertising further comprises generating revenue from advertising that is shared with at least one the schools, teams, and community.

13. The machine-readable medium comprising instructions according to claim 10 wherein at least one of the academic, extracurricular activity, high school, youth level, club level, and adult league sports based content comprises at least one of game schedules & results, game headlines, detailed athlete, team, school, conference statistics, news articles, photo galleries, video content, system generated sports statistics, league standings, league leaders, conference schedules, players, articles, leagues, win-loss records schedules, playoffs, games, highlights, bloopers, and internet radio information.

14. The machine-readable medium comprising instructions according to claim 10 further comprising instructions for generating statistical and video information of at least one of the schools, teams, players, and students.

15. The machine-readable medium comprising instructions according to claim 10 further comprising instructions for allowing sports recruiters from colleges and universities to view the statistical and video information of at least one of the schools, teams, players, and students.

16. The machine-readable medium according to claim 10 further comprising instructions wherein said instructions for generating web pages for at least one of schools, teams, players, and students comprises allowing at least one of players and students to personalize the academic, extracurricular activity, high school, youth level, club level, and adult league sports based content.

17. The machine-readable medium according to claim 10 wherein the portal forms a single point of access for a community.

18. The machine-readable medium according to claim 10 wherein said instructions for generating web pages for at least one of schools, teams, players, and students takes place locally in the community.

19. A process of generating a web-based high school sports, academic, extracurricular activity, youth/club level youth sports and adult sports league website portal comprising the steps of:
receiving at least one of academic, extracurricular activity, high school, youth level, club level, and adult league sports based content from users;
generating web pages for at least one of schools, teams, players, and students allowing users to view at least one of the academic, extracurricular activity, high school, youth level, club level, and adult league sports based content of at least one of the schools, teams, players, and students; and
directing advertising to the users through interaction with the web pages based on at least one the schools, teams, players, and students, wherein at least one of the academic, extracurricular activity, high school, youth level, club level, and adult league sports based content comprises at least one of game schedules & results, game headlines, detailed athlete, team, school, conference statistics, news articles, photo galleries, video content, system generated sports statistics, league standings, league leaders, conference schedules, players, articles, leagues, win-loss records schedules, playoffs, games, highlights, bloopers, and internet radio information.

20. The process of generating according to claim 19 wherein the step of directing advertising comprises directing advertising limited to at least one gender, age, locality, specific school, town, city, region, and sport.

21. The process of generating according to claim 19 wherein the step of directing advertising further comprises generating revenue from the advertising that is shared with at least one the schools, teams, and community.

22. The process of generating according to claim 19 further comprising the step of generating statistical and video information of at least one of the schools, teams, players, and students.

23. The process of generating according to claim 19 further comprising the step of allowing sports recruiters from colleges and universities to view the statistical and video information of at least one of the schools, teams, players, and students.
